(19) United States
(12) Patent Application Publication
(10) Pub. No.: US 2011/0238810 A1
(43) Pub. Date: Sep. 29, 2011

(54) SYSTEM AND METHOD FOR STATE MANAGEMENT BASED ON INSTANT MESSAGING PLATFORM

(75) Inventors: Bin Liang, Guangdong province (CN); Pisuo Cui, Guangdong province (CN); Jianfeng Lu, Guangdong province (CN); Qinyuan Lu, Guangdong province (CN)

(73) Assignee: ZTE CORPORATION

(21) Appl. No.: 13/120,639

(22) PCT Filed: Aug. 3, 2009
(86) PCT No.: PCT/CN09/73052

§ 371 Date: May 31, 2011

(30) Foreign Application Priority Data
Sep. 24, 2008 (CN) 200810216542.7

(51) Int. Cl. G06F 15/173

(52) U.S. Cl. 709/223

(57) ABSTRACT

The present invention discloses a system and a method for state management based on an instant messaging platform. The system comprises a client, a registration application server, a PS application server, and at least one third party server. The method includes the third party server searching its database according to client login information, obtaining the group information of the client and member information of the group, and returning the group information and the member information of the group to the client; then the client sending its current state and group information to the PS application server; and the PS application server, after receiving the current state and group information, sending states of other on-line members in the group to the client, and forwarding the current state of the client to other on-line members in the group. The present invention separates user management from state management in the instant messaging; its PS application server only performs state management; group and user information are stored specifically in other third party server(s), thereby not only decreasing the load of other parts of the system but also reducing the network overhead for realizing smooth operation.

### FIELD OF THE INVENTION

The present invention belongs to the field of state presence in an instant messaging platform, and particularly relates to a system and a method for state management based on an instant messaging platform.

### BACKGROUND OF THE INVENTION

Instant messaging provides for a user a convenient and rapid way of communicating with friends via a network, through which people can view good friends, chat on line, transmit files mutually, conduct a voice dialogue, have a video conference, and even make bidirectional communication on a cell phone.

An instant messaging client obtains packet user information from an instant messaging application server (instant messaging AS) and can distinguish the states of the user such as on line, off line, and the like. In a large-sized instant messaging system, the instant messaging AS needs to be frequently accessed while inquiring user packet information and user states, thereby increasing the system load and network overhead and influencing the system performance.

### SUMMARY OF THE INVENTION

The object of the present invention is to overcome the shortcomings of the prior art and to provide a system and a method for state management based on an instant messaging platform. The present invention separates user management from state management in an instant messaging to decrease the system load and reduce the network overhead.

In order to solve the above technical problem, the present invention is realized by the following technical solutions:

According to one aspect of the present invention, there is provided a system for state management based on an instant messaging platform.

The system for state management based on an instant messaging platform according to the present invention comprises: a client, a registration application server, and a state presence application server, wherein
the client is configured to send a login request message via a network to the registration application server;
the registration application server performs an authentication process on the client according to the login request message sent by the client and sends client login information;
the state presence application server (Presence application server, viz. PS application server) is configured to manage group information of the client and member information of the group;
the system further comprises at least one third party server configured to receive the client login information sent by the registration application server, search the group information of the client according to the client login information, and return to the client the group information and the member information of the group via the network.

In the above mentioned system, the client can be a PC, a PAD, a cell phone or the like.

In the above mentioned system, the client is connected to the registration application server via an access gateway of the network.

In the above mentioned system, the access gateway is a broadband gateway.

According to another aspect of the present invention, there is provided a method for state management based on an instant messaging platform.

The method for state management based on an instant messaging platform according to the present invention comprises the following steps:

A, a client sending a login request message via a network to a registration application server;

B, the registration application server receiving the login request message sent by the client and performing authentication on the client, and sending, after the authentication is passed, client login information to a third party server;

C, the third party server searching its database according to the client login information, obtaining group information of the client and member information of the group, and returning to the client the group information and the member information of the group via a network;

D, the client receiving the group information and the member information of the group sent by the third party server and sending its current state and the group information via a network to a state presence application server; and

E, the state presence application server receiving the current state and the group information of the client, sending states of other on-line members in the group to the client, and forwarding the current state of the client to other on-line members in the group.

The login request message in the step A is consisted of a username and a password.

The client login information in the step B comprises client identity information and IP address and port number of the client.

The group information of the client in the step C comprises a group name and an identifier, wherein the identifier possesses uniqueness.

The step D comprises specifically:

step D1, the client receiving and storing the group information and the member information of the group sent by the third party server;

step D2, the client sending the current state to the state presence application server; and

step D3, the client sending the group information received from the third party server to the state presence application server.

The step E comprises specifically:

step E1, the state presence (PS) application server receiving the group information sent by the client, and determining whether the group information is established on the PS application server or not, wherein if it is established, entering step E2; otherwise, establishing the group information and then entering step E2;

step E2, the PS application server determining whether the client member is established in the group, wherein if it is established, entering step E3; otherwise, establishing the client member in the group and then entering step E3;

step E3, the PS application server storing the state of the client member in the group as the current state sent by the client, and sending the current states of other on-line members in the group to the client; and

step E4, the PS application server forwarding the current state of the client to other on-line members in the group.

The present invention has the following beneficial effects as compared with the prior arts: the present invention separates user management from state management in the instant messaging, wherein its PS application server only performs state management, and group and user information are stored specifically in other third party server(s). A plurality of groups are established in the third party server, and the user information is stored in the group, thereby not only decreasing the load of other parts of the system but also reducing the network overhead and realizing smooth operation.

Other features and advantages of the present invention will be described in the following description and partly become obvious from the description, or be understood by implementing the present invention. The objects and other advantages of the present invention can be realized and obtained through the structures indicated by the description, claims and drawings.

### BRIEF DESCRIPTION OF THE DRAWINGS

The drawings provide a further understanding of the present invention and form a part of the Description. The drawings together with the embodiments of the present invention are used to explain the present invention without limiting the same, wherein:

FIG. 1 is a schematic diagram showing a system for state management based on an instant messaging platform according to an embodiment of the present invention; and

FIG. 2 is a flow chart showing a method for state management based on an instant messaging platform according to an embodiment of the present invention.

### DETAILED DESCRIPTION OF EMBODIMENTS

In order to provide a better understanding of the present invention, the present invention will be further described hereinafter by the specific embodiments in combination with the drawings. It shall be understood that the preferable embodiments described herein are provided only for illustrating and explaining the present invention, not for limiting the present invention.

In the case that no confliction arises, the embodiments and the features of the embodiments in the present application can be combined with one another.

According to an embodiment of the present invention, there is first provided a system for state management based on an instant messaging platform.

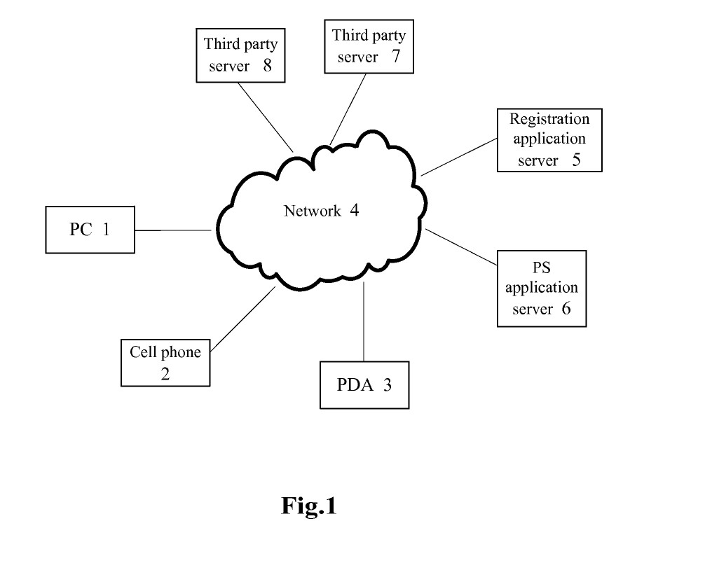

Referring to FIG. 1, the system for state management based on an instant messaging platform in the present invention comprises clients 1, 2, 3 (the clients 1, 2, 3 can be devices such as a PC, a cell phone, a PDA, or the like), a network 4, a registration application server 5, a PS application server 6, and two third party servers 7, 8.

A certain client sends a login request message via an access gateway of the network 4 to the registration application server 5. The registration application server 5 performs authentication on the client according to the login request message sent by the client and sends client login information to the third party server 7 or 8 after the authentication is passed. The third party server 7 or 8 searches group information of the client according to the client login information, and returns the group information and the member information of the group via the access gateway of the network 4 to the client after receiving the client login information sent by the registration application server 5. After receiving the group information and the member information of the group sent by the third party server, the client sends its current state and group information via the access gateway of the network 4 to the PS application server 6. The PS application server 6 manages the group information of the client and the member information of the group, and can send the states of other on-line members in the group to the client and forwards the current state of the client to other on-line members in the group.

The access gateway of the above mentioned network 4 can be a broadband gateway (BGW).

According to an embodiment of the present invention, there is also provided a method for state management based on an instant messaging platform.

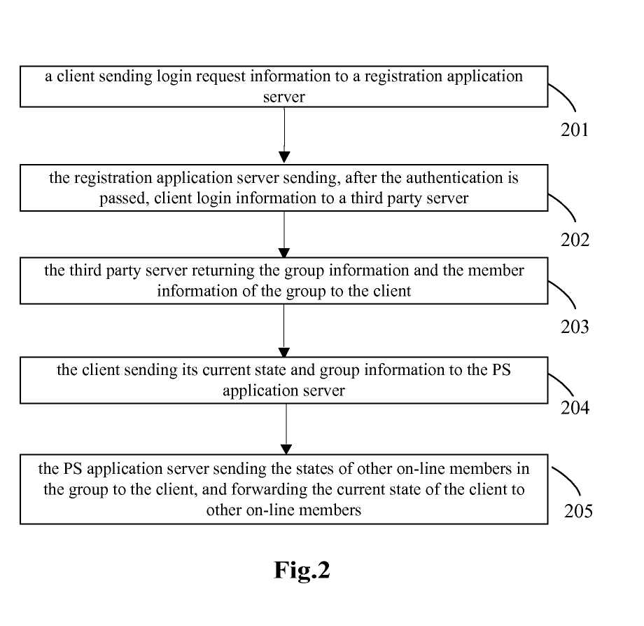

Referring to FIG. 2, the method for state management based on an instant messaging platform comprises the following steps:

201, a certain client sending a login request message consisted of a username and a password via an access gateway of a network to a registration application server;

202, the registration application server receiving the login request message sent by the client, performing authentication on the client, and sending, after the authentication is passed, client login information to a third party server, the step comprising specifically:

step a. the registration application server receiving the login request message sent by the client and performing authentication on the user identity thereof; returning a response of successful login to the client and entering step b if the authentication is passed; and returning failure indication information if the authentication fails; and

step b. sending the client login information consisted of client identity information and the IP address and port number of the client to the third party server;

203, the third party server searching its database according to the client identity information in the client login information, obtaining the group information of the client and the member information of the group, and returning the group information and the member information of the group via the network to the client according to the IP address and the port number of the client; wherein the group information comprises a group name and an identifier, the identifier possessing uniqueness;

204, the client receiving the group information and the member information of the group sent by the third party server and sending its current state and group information via the network to the PS application server, the step comprising specifically:

step c, the client receiving and storing the group information and the member information of the group sent by the third party server;

step d, the client sending its current state to the PS application server; and

step e, the client sending the group information received from the third party server to the PS application server;

205, the PS application server receiving the current state and the group information of the client, sending the states of other on-line members in the group to the client, and forwarding the current state of the client to other on-line members in the group, the step comprising specifically:

step f, the PS application server receiving the group information sent by the client; if the group information has been established on the PS application server, entering step g; otherwise, establishing the group information and entering step g;

step g, the PS application server determining whether the client member is established in the group or not; if it is established, entering step h; otherwise, establishing the client member in the group and entering step h;

step h, the PS application server storing the state of the client member in the group as the current state sent by the client and sending the current states of other on-line members in the group to the client; and

step i, the PS application server forwarding the current state of the client to other on-line members in the group.

As described above, by means of the technical solutions provided in the embodiments of the present invention, user management is separated from state management in the instant messaging, wherein its PS application server only performs state management, and group and user information are stored specifically in other third party server(s). A plurality of groups are established in the third party server, and the user information is stored in the group, thereby not only decreasing the load of other parts of the system but also reducing the network overhead and realizing smooth operation.

The descriptions above are only preferable embodiments of the present invention, which are not used to restrict the present invention. For those skilled in the art, any amendments, equivalent substitutions, improvements, etc. within the spirit and principle of the present invention are all concluded in the scope of protection of the present invention.

1. A system for state management based on an instant messaging platform, comprising:
a client, configured to send a login request message via a network to a registration application server;
the registration application server, configured to perform an authentication process on the client according to the login request message sent by the client and send client login information; and
a state presence application server, configured to manage group information of the client and member information of the group;
the system further comprising at least one third party server configured to receive the client login information sent by the registration application server, search the group information of the client according to the client login information, and return to the client the group information and the member information of the group via the network.

2. The system for state management based on an instant messaging platform according to claim 1, wherein the client is a PC, a PAD, or a cell phone.

3. The system for state management based on an instant messaging platform according to claim 1, wherein the client is connected to the registration application server via an access gateway of the network.

4. The system for state management based on an instant messaging platform according to claim 3, wherein the access gateway is a broadband gateway.

5. A method for state management based on an instant messaging platform, by comprising the following steps:
A, a client sending a login request message via a network to a registration application server;
B, the registration application server receiving the login request message sent by the client and performing authentication on the client, and sending, after the authentication is passed, client login information to a third party server;
C, the third party server searching its database according to the client login information, obtaining group information of the client and member information of the group, and returning to the client the group information and the member information of the group via a network;
D, the client receiving the group information and the member information of the group sent by the third party server and sending its current state and the group information via a network to a state presence application server; and
E, the state presence application server receiving the current state and the group information of the client, sending states of other on-line members in the group to the client, and forwarding the current state of the client to other on-line members in the group.

6. The method for state management based on an instant messaging platform according to claim 5, wherein the login request message in the step A is consisted of a username and a password.

7. The method for state management based on an instant messaging platform according to claim 5, wherein the client login information in the step B comprises client identity information and IP address and port number of the client.

8. The method for state management based on an instant messaging platform according to claim 7, wherein the group information of the client in the step C comprises a group name and an identifier, wherein the identifier possesses uniqueness.

9. The method for state management based on an instant messaging platform according to claim 8, wherein the step D specifically comprises:
step D1, the client receiving and storing the group information and the member information of the group sent by the third party server;
step D2, the client sending the current state to the state presence application server; and
step D3, the client sending the group information received from the third party server to the state presence application server.

10. The method for state management based on an instant messaging platform according to claim 9, wherein the step E specifically comprises:
step E1, the state presence (PS) application server receiving the group information sent by the client, and determining whether the group information is established on the PS application server or not, wherein if it is established, entering step E2; otherwise, establishing the group information and then entering step E2;
step E2, the PS application server determining whether the client member is established in the group, wherein if it is established, entering step E3; otherwise, establishing the client member in the group and then entering step E3;
step E3, the PS application server storing the state of the client member in the group as the current state sent by the client, and sending the current states of other on-line members in the group to the client; and
step E4, the PS application server forwarding the current state of the client to other on-line members in the group.

11. The method for state management based on an instant messaging platform according to claim 6, wherein the client login information in the step B comprises client identity information and IP address and port number of the client.

12. The method for state management based on an instant messaging platform according to claim 11, wherein the group information of the client in the step C comprises a group name and an identifier, wherein the identifier possesses uniqueness.

13. The method for state management based on an instant messaging platform according to claim 12, wherein the step D specifically comprises:
step D1, the client receiving and storing the group information and the member information of the group sent by the third party server;
step D2, the client sending the current state to the state presence application server; and
step D3, the client sending the group information received from the third party server to the state presence application server.

14. The method for state management based on an instant messaging platform according to claim 13, wherein the step E specifically comprises:
step E1, the state presence (PS) application server receiving the group information sent by the client, and determining whether the group information is established on the PS application server or not, wherein if it is established, entering step E2; otherwise, establishing the group information and then entering step E2;
step E2, the PS application server determining whether the client member is established in the group, wherein if it is established, entering step E3; otherwise, establishing the client member in the group and then entering step E3;
step E3, the PS application server storing the state of the client member in the group as the current state sent by the client, and sending the current states of other on-line members in the group to the client; and
step E4, the PS application server forwarding the current state of the client to other on-line members in the group.
